(19) United States
(12) Patent Application Publication
(10) Pub. No.: US 2025/0315747 A1
(43) Pub. Date: Oct. 9, 2025

(54) SYSTEM AND METHOD FOR DISTRIBUTING INTERACTION DATA TO AGENTS

(71) Applicant: NICE LTD., Ra'anana (IL)

(72) Inventors: Salil DHAWAN, Pune (IN); Rahul VYAS, Jodhpur (IN); Noam Zeev KAPLAN, Tel-Aviv (IL); Christopher SEAMAN, South Jordan, UT (US)

(73) Assignee: NICE LTD., Ra'anana (IL)

(21) Appl. No.: 18/626,893

(22) Filed: Apr. 4, 2024

(51) Int. Cl. G06Q 10/0631

(52) U.S. Cl. CPC G06Q 10/06311

(57) ABSTRACT

A system and method for distributing interaction data to agents may include a computing device; a memory; and a processor, the processor configured to: identify one or more interaction events from interaction metadata items located in one or more interactions assigned to an agent; generate a prediction prompt for estimating one or more future interaction events for said one or more interactions based on said identified interaction events; and apply said prediction prompt to a machine learning model to estimate said one or more future interaction events for said one or more interactions.

### TECHNICAL FIELD OF THE INVENTION

The present invention relates generally to the distribution of interaction data to agents, specifically to the estimation of interaction events based on previously identified interaction events.

### BACKGROUND OF THE INVENTION

Contact center agents can concurrently interact with several customers in multiple text-based interactions, e.g. chat sessions, since they are asynchronous. When one or more interaction requests are assigned to an agent who is already handling an interaction, the agent may interact with several customers at the same time. However, since the agent may be required to engage with several customers at the same time, interaction durations as well as response times of the agent to customer queries may increase.

When an agent has been assigned to a certain number of concurrent interactions, the risk of an agent experiencing stress or exhaustion may be increased and, as a result, the quality of an agent's response to a customer query may be reduced, e.g. by omitting relevant details in an answer to a customer.

Further, inefficient routing of interaction requests to agents may lead to imbalanced distributions of interactions to agents in contact centers and may lead to agents either experiencing high work pressure or lacking work load.

Thus, there is a need for a solution that allows for identifying workload capacity of agents, automatically distributing interactions to agents and/or managing and predicting workload for agents, e.g. contact center agents to increase their productivity but prevent agents becoming overwhelmed by an assigned workload.

### SUMMARY OF THE INVENTION

Improvements and advantages of embodiments of the invention may include automatically predicting interaction events for interactions, e.g. between agents and customers and distributing workload for agents based on generated predictions. Embodiments may more efficiently distribute data such as interaction data in a call center.

In one aspect, the present invention allows the individual assignment of workload, e.g. interactions to agents based on skill and experience of agents enabling control on the number of concurrent interactions based on individual agent abilities.

In another aspect, the present invention allows equally distributing interaction data, e.g. workload such as interactions, between agents of a contact center, thereby maximizing the availability of agents for interaction requests and, thus, increasing the productivity of contact centers.

One embodiment may include a method of distributing interaction data to agents, the method including: identifying one or more interaction events from interaction metadata items located in one or more interactions assigned to an agent; generating a prediction prompt for estimating one or more future interaction events for said one or more interactions based on said identified interaction events; and applying said prediction prompt to a machine learning model to estimate said one or more future interaction events for said one or more interactions.

In one embodiment, said one or more future interaction events include interaction termination.

In one embodiment, said one or more future interaction events include initiating a new interaction.

In an embodiment, estimating said one or more future interaction events includes determining a latency in responses of said agent to one or more interactions.

In an embodiment, estimating said one or more future interaction events includes sequential initiation and termination of said one or more interactions, thereby maintaining a concurrent assignment of interaction requests to said agent.

One embodiment includes identifying an interaction capacity of said agent from said interaction metadata items; and evaluating, using machine learning, whether said agent has capacity to receive a new interaction request.

In an embodiment, said interaction capacity is identified based on the evaluation of agent data items.

In one embodiment, evaluating said interaction capacity of said agent includes comparing an interaction latency of an agent to a threshold value.

In one embodiment, said agent is available for receiving said new interaction request when said interaction latency is below said threshold value and wherein said agent is unavailable for receiving said new interaction request when said latency is above said threshold value.

In one embodiment, when said agent is unavailable for receiving an interaction request, identifying another agent for receiving said interaction request.

One embodiment may include a system for distributing interaction data to agents, the system including: a computing device; a memory; and a processor, the processor configured to: identify one or more interaction events from interaction metadata items located in one or more interactions assigned to an agent; generate a prediction prompt for estimating one or more future interaction events for said one or more interactions based on said identified interaction events; and apply said prediction prompt to a machine learning model to estimate said one or more future interaction events for said one or more interactions.

One embodiment may include a method for predicting interaction events, the method including: identifying a plurality of interaction events from metadata items present in one or more interactions; generating a prediction prompt for determining at least one future interaction event for said one or more interactions based on said plurality of identified interaction events; and subjecting said prediction prompt to a machine learning model to determine at least one future interaction event for said one or more interactions.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device which may be used with embodiments of the present invention.

FIG. 2 is a schematic drawing of a system for generating evaluation forms from interaction transcripts, according to some embodiments of the invention.

FIG. 3 depicts a flowchart of methods of distributing interaction data to agents, according to some embodiments of the present invention.

FIG. 4 is a high-level block diagram showing exemplary operations in the distribution of interaction data to agents, specifically in the generation of prediction prompts and the estimation of future interaction events for interactions, according to some embodiments of the present invention.

FIG. 5 is a high-level block diagram showing exemplary operations in the assignment of an agent to an interaction request, according to some embodiments of the invention.

FIG. 6 shows an example system of a neural network architecture for operations in the distribution of interaction data to agents, according to some embodiments of the present invention.

FIG. 7 is an illustration of exemplary timelines for three interactions between an agent and three customers, according to some embodiments of the present invention.

FIG. 8 is an illustration of exemplary timelines for three interactions between an agent and three customers, according to some embodiments of the present invention.

FIG. 9A shows a schematic illustration of an interaction sequence between a customer and an agent, according to some embodiments of the present invention.

FIG. 9B discloses a schematic illustration of interaction sequences for a case in which an agent handles three interactions, according to some embodiments of the present invention.

FIG. 10 illustrates a distribution of interaction data to agents in a regular simulation as known in the art and in an augmented simulation, according to some embodiments of the present invention.

FIG. 11 illustrates an assignment of a first interaction to an agent in a regular simulation and in an augmented simulation, according to some embodiments of the present invention.

FIG. 12 illustrates an assignment of a second interaction to an agent in a regular simulation and in an augmented simulation, according to some embodiments of the present invention.

FIG. 13 illustrates an assignment of a third interaction to an agent in a regular simulation and in an augmented simulation, according to some embodiments of the present invention.

FIG. 14 is a schematic drawing of a recurrent neural network model, according to some embodiments of the present invention.

FIG. 15 is a schematic drawing of an LSTM model, according to some embodiments of the present invention.

FIG. 16 is a schematic drawing of a forget gate of an LSTM model, according to some embodiments of the present invention.

FIG. 17 is a schematic drawing of a input gate of an LSTM model, according to some embodiments of the present invention.

FIG. 18 is a schematic drawing of a output gate of an LSTM model, according to some embodiments of the present invention.

FIG. 19 depicts an example user interface in form of a quality planner, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “contact center” may refer to a centralized office used for receiving or transmitting a large volume of enquiries, communications, or interactions. The enquiries, communications, or interactions may include telephone calls, emails, message chats, SMS (short message service) messages, etc. A contact center may, for example, be operated by a company to administer incoming product or service support or information enquiries from customers/consumers. The company may be a contact-center-as-a-service (CCaaS) company.

As used herein, “call center” may refer to a contact center that primarily handles telephone calls rather than other types of enquiries, communications, or interactions. Any reference to a contact center herein should be taken to be applicable to a call center, and vice versa.

As used herein, “interaction” may refer to a communication between two or more people (e.g., in the context of a contact center, an agent and a customer), typically via devices such as computers, customer devices, agent devices, etc., and may include, for example, voice telephone calls, conference calls, video recordings, face-to-face interactions (e.g., as recorded by a microphone or video camera), emails, web chats, SMS messages, etc. An interaction may be recorded to generate an “interaction recording”. An interaction or interaction recording may also refer to the data which is distributed, transferred or stored in a computer system recording the interaction (for example the data stream distributed to an agent), and the data representing the interaction, including for example voice or video recordings, data items describing the interaction or the parties, a text-based transcript of the interaction, etc. Interactions as described herein may be “computer-based interactions”, e.g., one or more voice telephone calls, conference calls, video recordings/streams of an interaction, face-to-face interactions (or recordings thereof), emails, web chats, SMS messages, etc. Interactions may be computer-based if, for example, the interaction has associated data or metadata items stored or processed on a computer, the interaction is tracked or facilitated by a server, the interaction is recorded on a computer, data is extracted from the interaction, etc. Some computer-based interactions may take place via the internet, such as some emails and web chats, whereas some computer-based interactions may take place via other networks, such as some telephone calls and SMS messages. An interaction may take place using text data, e.g., email, web chat, SMS, etc., or an interaction may not be text-based, e.g., voice telephone calls. Non-text-based interactions may be converted into text-based interaction recordings (e.g., using automatic speech recognition). Interaction data and Interaction recordings may be produced, transferred, received, etc., asynchronously. For example, one or more interactions may be assigned to an agent at the same time or at different times. An agent, e.g. an agent of a contact center may handle one or more interactions, e.g. with customers, concurrently—at the same time—or one interaction at a time.

As used herein, “customer” may refer to a customer interacting with a contact center, e.g. with an agent of a contact center. A customer may initiate an interaction with an agent by sending an interaction request to a contact center. Alternatively, an agent may initiate an interaction with a customer by sending an interaction request to a customer.

As used herein, “agent” may refer to a contact center employee that answers incoming interactions, and may, for example, handle customer requests, e.g. customer interaction requests.

An “interaction event” may refer to or describe an item that is part of an interaction, or an action or event that occurs to or as part of the interaction. An interaction event may be identified from interaction data items which are generated, e.g. the recording of a time and date when an interaction is initiated or terminated. For example, an interaction event related to an interaction may be an initiation or termination of the interaction between an agent and a customer or a reply of an agent to a customer message present in an interaction or a reply of a customer to an agent message present in an interaction. An interaction event may also relate to re-routing of an interaction, e.g. between a customer C interacting with agent A to an interaction of customer C interacting with agent B, e.g. when agent B has a certain skill that allows agent B to provide a customer with a particular piece of information which is not available to agent A, e.g. information related to a product X or a service Y.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms. In a supervised ML approach, input sample data may include data which is labeled, for example, in the present application, the input sample data may include a transcript of an interaction and a label indicating whether or not the interaction was satisfactory. In an unsupervised ML approach, the input sample data may not include any labels, for example, in the present application, the input sample data may include interaction transcripts only.

ML models may, for example, include Large Language Models (LLM) such as Generative Pre-Trained Transformer (GPT), Bidirectional Encoder Representations from Transformers (BERT), Pathways Language Model (PaLM) and the like, (artificial) neural networks (NN), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

For the distribution of interaction data to agents, e.g. the distribution of calls to agents based on estimated future interaction events generated by a prediction prompt, interaction data or an interaction recording may be separated into words that are analyzed using an LSTM model. For example, data items such as interaction metadata items present in an interaction or sentences of an interaction, such as an interaction transcript, may be divided into one or more parts which may be used in the generation of a prediction prompt.

An LSTM model may be a recurrent neural network that is capable of learning long-term dependencies. Simple neural networks may process input data independently, e.g. without a connection between a first input and a second input after a certain period of time, e.g. after a second, a minute or an hour. An LSTM model may have a memory cell that can store information for a long range, allowing the network to capture long-term dependencies in sequential data. A memory cell may act as a “neuron” that can capture information from previous inputs and remember it for a certain time period of time, e.g. previously recorded time periods of interactions between customers and agents may be stored e.g. in storage 204 for a period of a week, a month, etc.

In practice, an LLM or NN, or NN learning, can be simulated by one or more computing nodes or cores, such as generic central processing units (CPUs, e.g., as embodied in personal computers) or graphics processing units (GPUs such as provided by Nvidia Corporation), which can be connected by a data network. A NN can be modelled as an abstract mathematical object and translated physically to CPU or GPU as for example a sequence of matrix operations where entries in the matrix represent neurons (e.g., artificial neurons connected by edges or links) and matrix functions represent functions of the NN.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

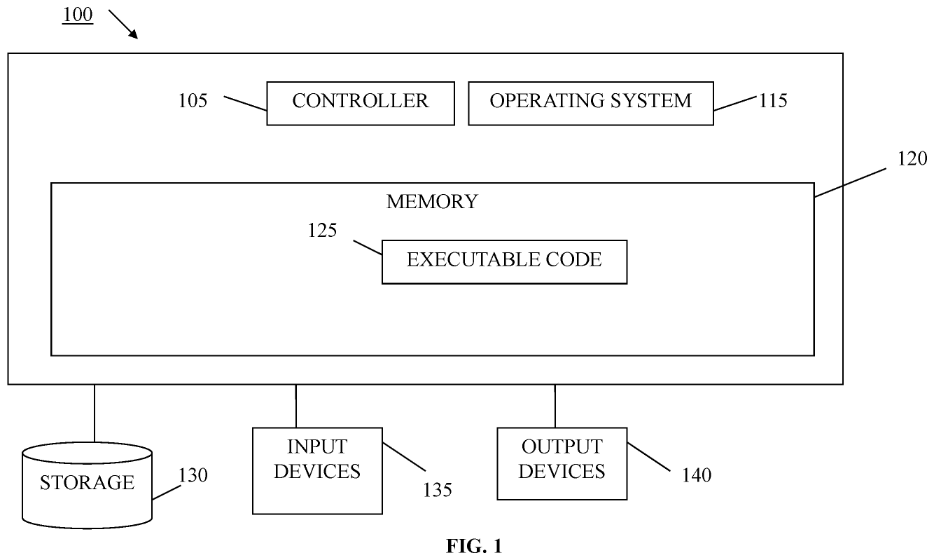

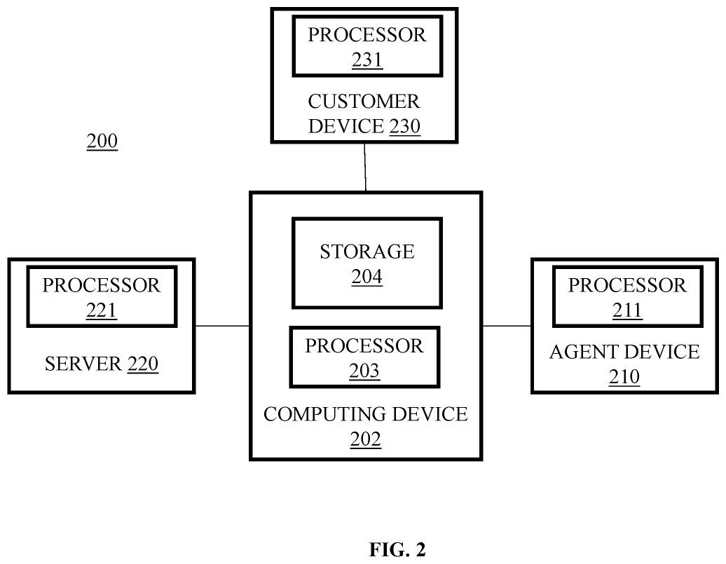

FIG. 1 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules and equipment and other devices and modules discussed herein, e.g. computing device 202, agent device 210, customer device 220, customer device 230, matching engine 406, model service 408, recommendation engine 502 or routing engine 504, and modules in FIGS. 2, 3, 4, 5, 6, 7, 8, 9A, 9B, 10, 11, 12, 13, 14, 15, 16, 17, 18, 19 may be or include, or may be executed by, a computing device such as included in FIG. 1 although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data.

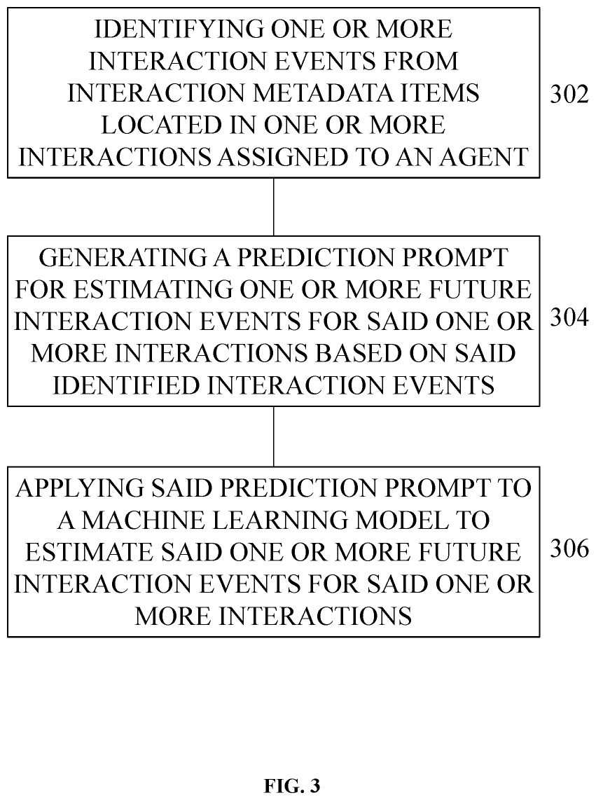

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 3 or other figures, or other methods, according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by, for example, executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

FIG. 2 is a schematic drawing of a system 200 according to some embodiments of the invention. System 200 may include a computing device 202 including a processor 203 and storage 204. Computing agent device 202 may be connected to an agent device 210 that includes processor 211. Computing device 202 may be connected to a server 220 including processor 221. Computing device 202 may be connected to a customer device 230 including processor 231. Server 220 and agent device 210 may provide computing device 202 with interaction recordings. Alternatively, interaction recordings may be stored in storage 204 of computing device 202.

Computing devices 100, 202, 210, 220 and 230 may be servers, personal computers, desktop computers, mobile computers, laptop computers, and notebook computers or any other suitable device such as a cellular telephone, personal digital assistant (PDA), video game console, etc., and may include wired or wireless connections or modems. Computing devices 100, 202, 210, 220 and 230 may include one or more input devices, for receiving input from a user (e.g., via a pointing device, click-wheel or mouse, keys, touch screen, recorder/microphone, or other input components). Computers 100, 202, 210, 220 and 230 may include one or more output devices (e.g., a monitor, screen, or speaker) for displaying or conveying data to a user.

Any computing devices of FIGS. 1 and 2 (e.g., 100, 202, 210, 220 and 230), or their constituent parts, may be configured to carry out any of the methods of the present invention. Any computing devices of FIGS. 1 and 2, or their constituent parts, may include a matching engine 406, model service 408, recommendation engine 502 or routing engine 504, or another engine or module, which may be configured to perform some or all of the methods of the present invention. Systems and methods of the present invention may be incorporated into or form part of a larger platform or a system/ecosystem, such as agent management platforms. The platform, system, or ecosystem may be run using the computing devices of FIGS. 1 and 2, or their constituent parts. For example, a processor such as processor 203 of computing device 202 processor 211 of device 210, and/or processor 221 of computing device 220 may be configured to identify one or more interaction events from interaction metadata items located in one or more interactions assigned to an agent. For example, a processor such as processor 203, 211 and/or 221 may be configured to identify a plurality of interaction events from metadata items present in one or more interactions. A processor such as processor 203 of computing device 202 processor 211 of device 210, and/or processor 221 of computing device 220 may be configured to generate a prediction prompt for estimating one or more future interaction events for said one or more interactions based on said identified interaction events. For example, a processor such as processor 203, 211 and/or 221 may be configured to generate a prediction prompt for determining at least one future interaction event for said one or more interactions based on said plurality of identified interaction events. A processor such as processor 203 of computing device 202 processor 211 of device 210, and/or processor 221 of computing device 220 may be configured to apply said prediction prompt to a machine learning model to estimate said one or more future interaction events for said one or more interactions. For example, a language model may be configured to subject said prediction prompt to a machine learning model to determine at least one future interaction event for said one or more interactions. A processor such as processor 203 of computing device 202 processor 211 of device 210, and/or processor 221 of computing device 220 may be configured to retrieve interaction metadata items from an interaction. For example, a processor such as processor 203, 211 and/or 221 may be configured to retrieve a start time of an interaction, e.g. at the same time when an interaction is initiated between an agent and a customer, e.g. 12:26 initiation of an interaction between customer X and agent Y. A processor such as processor 203 of computing device 202 may be configured to distribute an interaction or an interaction request to an agent. For example, when a machine learning model estimated that a current interaction 1 between agent X and customer Y will end in 5 minutes, a machine learning model may prompt a routing service, e.g. ACD 404, to route or queue an interaction request for agent X and customer Z or initiate an interaction between agent X and customer Z in 5 min. A processor such as processor 203 of computing device 202 may be configured to re-distribute an interaction request assigned to agent A to agent B. For example, when an interaction event is identified in an interaction which may lead to a delay in the predicted termination of interaction 1, interaction request 2, which was assigned to agent A to start after termination of interaction 1, may be assigned from agent A to agent B. ACD 404 may distribute interaction data to agents based on an estimate or prediction of future interaction events.

FIG. 3 shows a flowchart of a method 300 of distributing interaction data to agents, e.g. interaction data received as part of interactions between an agent, e.g. agent using agent device 210 and customer using customer device 230 which may have been received by computing device 202. The system displayed in FIG. 2 and the method shown in FIG. 3 may refer to the generation of a prediction prompt used for estimating one or more future interaction events based on interaction metadata items present in previously identified interaction events which have been received from an agent device, e.g. 210, a database, e.g. server 220, or customer device 230, however, the system and the method may also be used to generate a prediction prompt when executed on a server or agent device. According to some embodiments, some or all of the steps of the method are performed (e.g., fully or partially) by one or more of the computational components, for example, those shown in FIGS. 1 and 2.

In operation 302, one or more interaction events may be identified from interaction metadata items located in one or more interactions assigned to an agent. An interaction event may be, for example the start or termination of an interaction between an agent A and a customer C. An interaction event may be the re-distribution of an interaction from a first agent to a second agent. An interaction event may be a future interaction event, e.g. an interaction event that is predicted, e.g. using machine learning, to occur at a determined time in the future. An interaction event, such as a past or existing interaction event, may be identified from metadata items that are generated by a computing device, e.g. by an automatic call distribution service (ACD) when an ACD distributes or allocates an interaction request from a customer to an available agent of a contact center. An agent may be available for being distributed an interaction request from a customer, e.g. when they have established a connection to an ACD service. Interaction metadata items may include data identifying or describing the interaction, as opposed to the core data of the interaction (such as audio data). For example, interaction metadata may include a start time for an interaction, e.g. 12:23:31 UTC or a time that has passed since the event of initiation of an interaction, e.g. 00:09:23 h.

For example, interaction metadata items “interactionDuration” or “interactionStartTime” may allow identifying an interaction event such as a start of an interaction and the time that has passed since the interaction has been initiated.

In operation 304, a prediction prompt for estimating one or more future interaction events may be generated for one or more interactions based on said identified interaction events. A prediction prompt may be natural language, e.g. in form of a question, and/or programming code or a snippet of programming code that includes data, e.g. interaction metadata items, related to or describing one or more interaction events. For example, in a case that an interaction event is an initiation of an interaction between an agent and a customer, a prediction prompt may include interaction metadata items that can describe the type of interaction event, e.g. initiation of a text-based interaction, the name of the parties, e.g. customer A and agent X, the purpose of an interaction, e.g. request to reset a password and/or an interaction time that is typically assigned for an interaction based on the purpose of an interaction, e.g. 9 minutes for a password reset interaction. A prediction prompt may also include a number of concurrent interactions for a specific agent, e.g. an agent may handle four interactions in parallel (concurrently) and may include interaction events for such interactions. A prediction prompt may also include response times of a specific agent to a specific a customer request within an interaction. E.g. when a customer asks a question such as “can you provide me with detailed steps to reset my password”, the time it takes an agent to reply to the question may be set as the response time of an agent to the question. Response times of agents to customer question may be influenced, e.g. by the number of concurrent interactions, the skill/experience of an agent and/or the type of question.

For example, an excerpt of a prompt for the generation of categories or sections may read:

# In [ ]: # Example: Predict response time for a new chat duration
new_chat_duration = np.array([[10, 15]]) # past chat durations
new chat duration = new_chat_duration.reshape((1, 1,
new_chat_duration.shape[1]))
predicted_response_time = model.predict(new_chat_duration)

In operation 306, a prediction prompt may be applied or input to a machine learning model, and the ML model may estimate or output one or more future interaction events for one or more interactions. Estimating one or more future interaction events for one or more interactions may include providing a machine learning model, e.g. an LLM, with a prediction generation prompt that may include one or more identified interaction events for one or more interactions. For example, a prediction prompt may be sent to an LLM, e.g. to estimate or predict future interaction events, such as a predicted end-time of an interaction. A ML model may predict a future interaction event based on input in form of a prediction prompt and may provide an output, e.g. in form of an estimated future interaction event, e.g. an output may include the type of interaction event, e.g. termination of an interaction and a predicted time for such an event, e.g. in relative time values such as 9 minutes or in an absolute time value, e.g. 12:26 pm.

Operations 302, 304 and 306 may be performed for one agent at a time based on the provided interaction data for one agent, but may also be performed for multiple agents at a time, e.g. concurrently in parallel. Initiation of operations 302, 304 and 306 may occur periodically, e.g. distribution of interaction data to agents in form of interaction requests or the estimation of predicted interaction events, may proceed every 20 seconds, every minute, or may occur when an interaction event for an agent is detected, e.g. a termination of a call is identified by an ACD.

In order to facilitate the estimation of one or more future interaction events, a latency in response times of an agent to one or more interactions may be determined, and may be included in a prompt as input to an ML model. For example, a response time for an agent to respond to a message received by a customer may be set as 30 seconds. In case that an agent takes 45 seconds to reply to a customer message, a latency may be calculated, for example by a code module or regression network 630, as the time difference between actual response time and a pre-set response time, e.g. 45 s−30 s=15 s. Latencies in response times may be a parameter that is incorporated in a prediction prompt and may be used by a ML model to estimate a future interaction event. For example, a latency in response times in an interaction may lead to a predicted postponement of an estimated future interaction event, such as termination of an interaction, to a later point in time.

Estimation of one or more future interaction events, e.g. termination times for interactions A, B and C, may allow sequential initiation and termination of interactions. For example, a predicted termination of 2 min and 5 min for interactions A and B and a predicted termination time of 10 min for interaction C may allow a service such as matching engine 406, to identify interaction requests, e.g. requests D and E received by an ACD, e.g. ACD 404, which can be routed to an agent in 2 and 5 minutes respectively, since the agent is likely to have completed interactions A and C in such a time period. Estimation of termination times of interactions may allow maintaining a concurrent assignment of interaction or interaction requests to an agent.

In the estimation of future interaction events, a ML model may be used to identify an interaction capacity of an agent based on an agent data items. Agent data items may be parameters or values, such as concurrency (how many interactions an agent can handle at the same time, e.g. 2, 3, 4 etc.) and skill (area of expertise of an agent, e.g. customer support, product queries), which characterize an agent or an agent's capabilities in dealing with interaction requests e,g, in handling interactions. For example, an interaction capacity may be a number of interactions that an agent can handle at the same time, e.g. three interactions. Interaction capacity may be included as a parameter in a prediction prompt to evaluate whether an agent can be assigned a new interaction request, e.g. an interaction request that has been received by an ACD. In some embodiments, agent data items are interaction metadata items.

In some embodiments, the identification of an interaction capacity of an agent includes comparing a latency of an agent to a threshold value. For example, a threshold value may be the average latency of all agents within a contact center. Comparison of a latency of an agent to a threshold value or to an average latency value may allow assessing whether an individual agent can provide one or more customers with a reply within a certain time period, e.g. 30 seconds. Comparison of a latency value for an agent to an average latency value, e.g. within a contact center may allow identifying agents that have a latency that is below an average latency value. When an agent's interaction latency is below a threshold value, it may be determined that an agent is available for receiving a new interaction request. When a latency is above said threshold value, it may be determined that an agent is unavailable for receiving a new interaction request. When an agent is unavailable for receiving an interaction request, an ACD service 404 may identify another agent for receiving the interaction request.

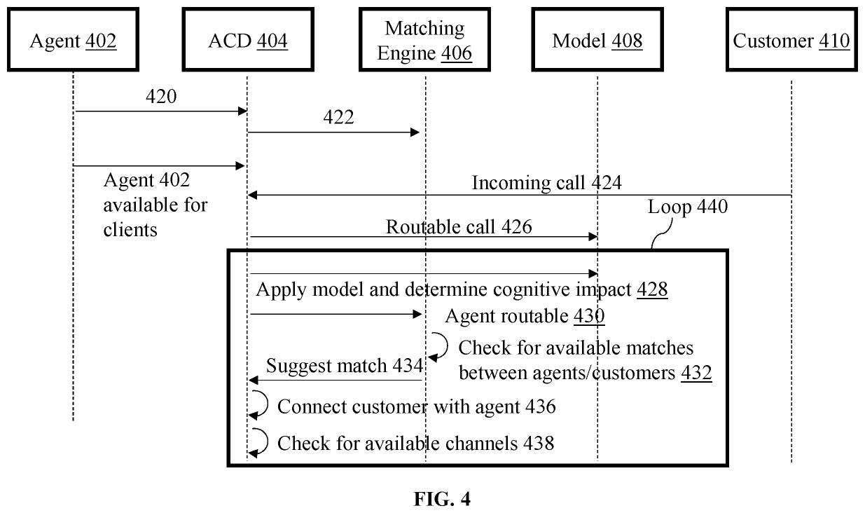

FIG. 4 is a high-level block diagram 400 showing exemplary operations in the distribution of interaction data to agents, specifically in the generation of prediction prompts and the estimation of future interaction events for interactions, e.g. interaction in a contact center. FIG. 4 shows steps the data flow between ACD 404, matching engine 406, ML model 408 and agents and customers of a contact center.

When an agent 402 is logged in (operation 420), e.g. connected to an ACD 404 of a contact center, agent 402 may be connected to matching engine 406 that connects incoming interaction requests for a contact center and available agents of a contact center. An ACD may provide a matching engine 406 with skills of agents who are available, e.g. who have logged in onto the ACD 404 (operation 422). An ACD system may route or distribute incoming interaction requests from customers 410 (operation 424), e.g. text chats, to a matching engine 406, that may access a ML model 408 of the system (operation 426). Based on a given time period for an agent for receiving interaction requests, e.g. 2 hours, a ML model may determine or predict future interaction events, e.g. expected response times of an agent for assigned interactions based upon a trained neural network (operation 428). For example, model 408 can estimate or determine a latency of an agent in responding to a message of a customer. When an agent is estimated to respond to customer interactions later than a defined latency, e.g. an average latency of 60 seconds, an agent may be considered unavailable for being assigned a new interaction request and a following interaction request may be assigned to a different agent. ACD 404 may provide matching engine 406 with agent data, e.g. matching engine 406 may retrieve information of ACD 404 whether an agent is available to be assigned an interaction request (operation 430). Matching engine 406 may assign agents to interaction requests of customers, e.g. by linking an agent skill to the type of interaction request (operation 432). A suggested match may be sent to ACD 404 (operation 434). ACD 404 may initiate an interaction between a customer and an agent (operation 436) and may select an available channel for an interaction, e.g. a text-based interaction such as a web chat (operation 438). In a contact center, operations 428-438, may be permanently executed by ACD 404, matching engine 406 and model 408, in a loop 440 to respond to incoming interaction requests of customers.

For example, when an interaction request for an agent is received, a ML model may predict an estimated response time for the interaction request. An interaction request may be assigned to an agent based on a given skill of an agent. Subsequent interaction requests which are received by a contact center may be dynamically assigned to agents, e.g. based on provided time periods in which agents are available and agent skill, using an ML model, e.g. a trained neural network 408 available in the system.

A neural network, e.g. network 408 or 630, may be trained based on previous interaction records, e.g. historical call/contacts with a target to predict/determine the response time required to answer given chat.

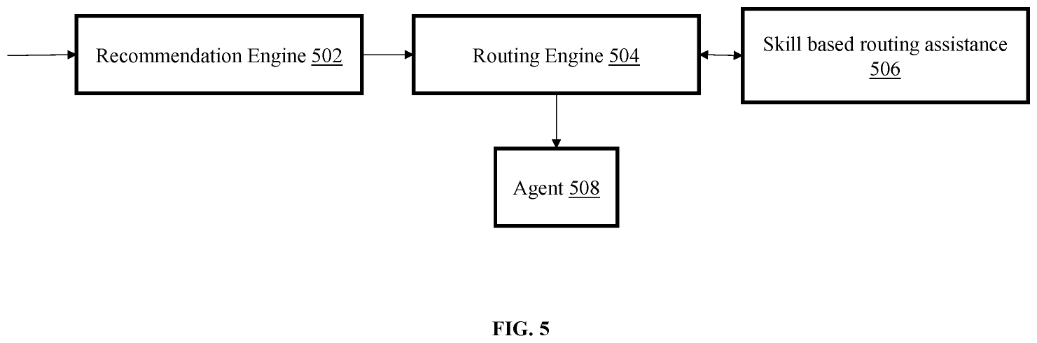

FIG. 5 is a high-level block diagram showing exemplary operations in the assignment of an agent to an interaction request. An incoming interaction request, e.g. by a customer using customer device 230, may be received at the ACD and may be transmitted to recommendation engine 502. Recommendation engine may identify available agents who can handle the interaction request, e.g. by evaluating interaction capacities for one or more agents, e.g. the number of concurrent interactions for one or more agents and/or the latency for replies in interactions handled by one or agents. For example, when an interaction latency is below said threshold value, an agent may be available for receiving an interaction request. When a latency is above a threshold value, an agent may be unavailable for receiving an interaction request. Data related to the availability/unavailability of agents for interaction requests may be sent to a routing engine 504 or an ACD, e.g. ACD 404. Routing engine 504 or ACD 404 may retrieve a list of available/unavailable agents for an interaction request and may select an agent, e.g. by comparing skills of available agents to skills required for handling an interaction request, e.g. by querying a routing assistance database 506. For example, when an interaction request includes a request for a skill “providing information about product X”, routing engine 504 may select an agent that has the skill “providing information about product X”. Routing engine 504 may assign an interaction to agent 508, e.g. based on evaluation of agent data provided from an recommendation engine and agent data provided from routing assistance database 506.

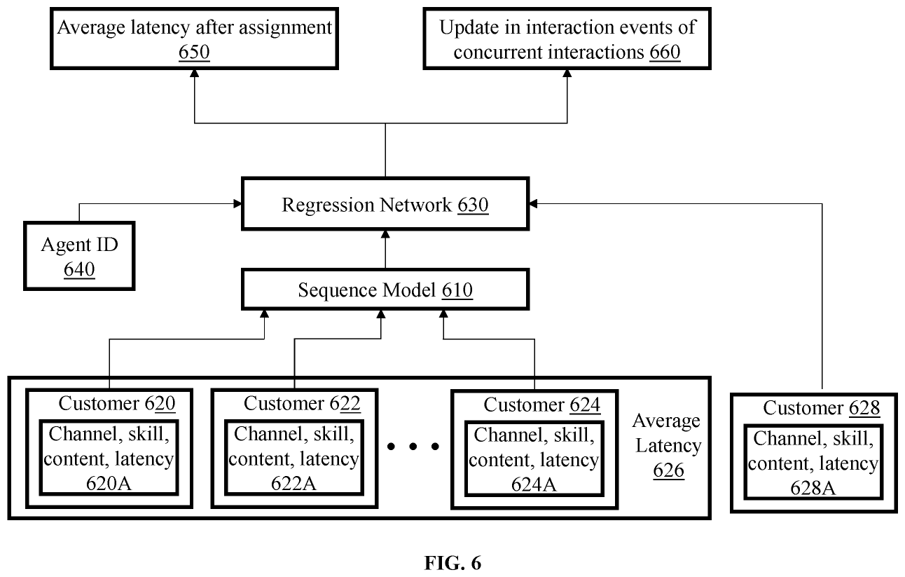

FIG. 6 shows an example system of a neural network architecture for operations in the distribution of interaction data to agents. A sequence model, e.g. model 610, may retrieve inputs, e.g. interaction metadata 620A, 622A, 624A from customers that may be in an interaction with an agent, e.g. customers 620, 622 and 624 and an average latency value 626. For example, sequence model 610 may be a machine learning model, e.g. an LSTM model such as model 408. An LSTM model may provide output to a regression network 630. Neural networks, e.g. regression networks, can be used for regression by learning a mapping from input features to a target output. For example, regression network 630 may be a machine learning network that can predict continuous numeric values, e.g. a latency in responses of an agent to one or more interactions, based on input data, e.g. interaction metadata items located in one or more interactions. Regression network 630 may receive data from agents, e.g. agent identifiers 640 for all available agents of a contact center. In addition regression network 630 may retrieve interaction metadata from customers that have sent an interaction request to a contact center, e.g. interaction metadata 628A of customer 628. Regression network 630 may estimate one or more future interaction events, e.g. an estimated duration of an interaction. Thus, the prediction of impact of concurrent assignment may be used to create a reliable model for optimize concurrency of interactions within a contact center. For example, after assignment of an interaction request, e.g. a request of customer 628, the average latency 650 may be updated based on the initiation of an interaction between an agent with an agent identifier 640 and the remaining interactions with customers 620, 622 and 624. Further, interaction events of concurrent interactions 660 may be updated in response to the assignment of an interaction request of customer 628 to agent 640.

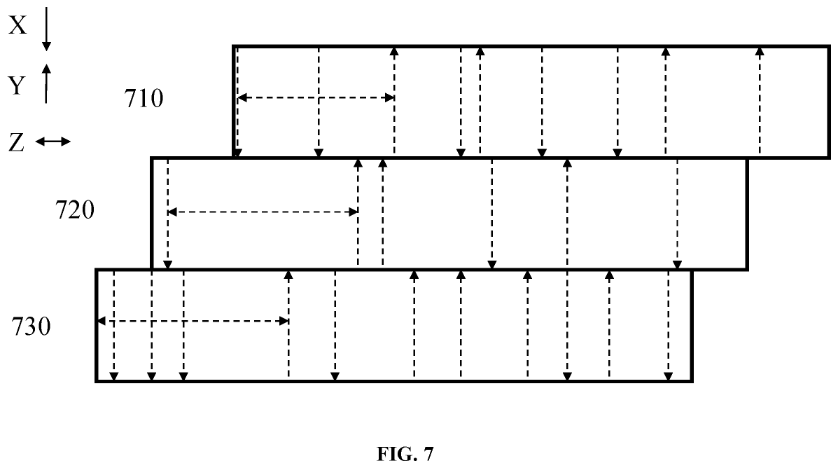

FIG. 7 is an illustration of exemplary timelines 710, 720 and 730 for three interactions between an agent and three customers. Incoming messages or interaction data from a customer may be indicated as an arrow point downwards (indicated as X direction) and outgoing messages by an agent may be indicated by an arrow point upwards (Y direction). Horizontal arrows (indicated as Z direction) may indicate how much time a customer may be required to wait before receiving a response from an agent. Initial waiting times for a customer to be assigned to an agent may vary, e.g. the waiting time may depend on the availability of an agent for having the capacity to handle a new customer request.

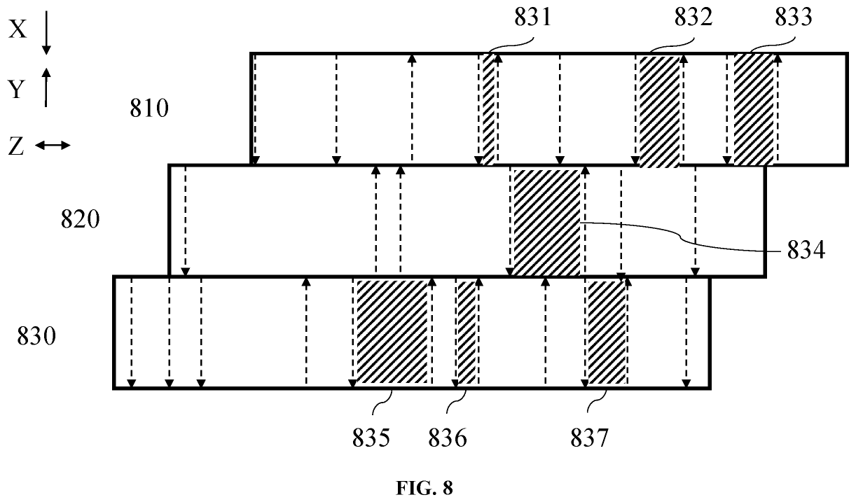

Latency may be measured as expired time until a customer receives a reply from an agent during an interaction, e.g. in a conversation between an agent and a customer, an agent may require 30 seconds to provide an agent with an answer to a question. FIG. 8 is an illustration of exemplary timelines 810, 820 and 830 for three interactions between an agent and three customers. In FIG. 8 periods of latency in a conversation between an agent and three customers in three separate interactions are indicated in sections 831-837.

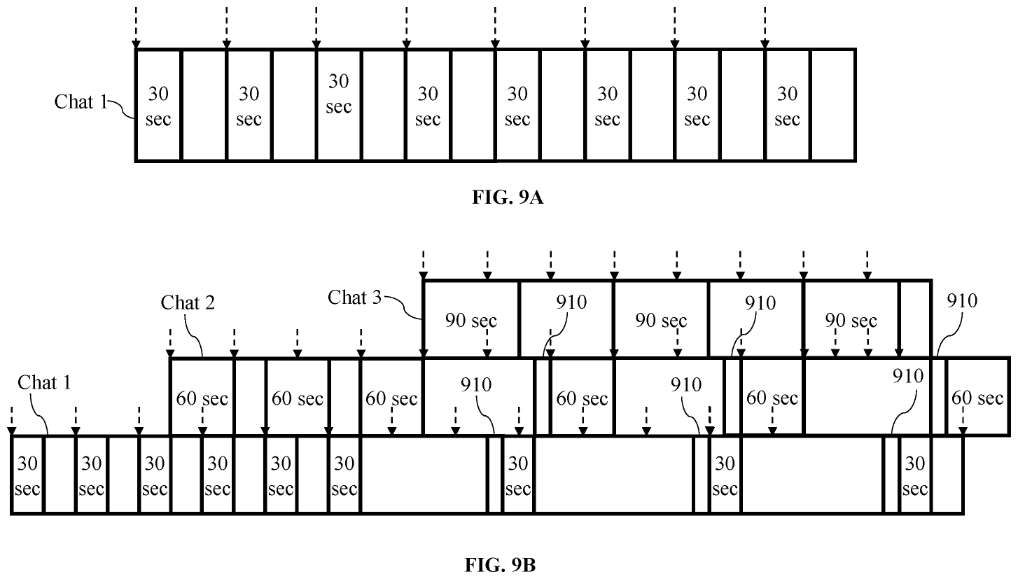

FIG. 9A shows a schematic illustration of an interaction sequence, e.g. chat 1, between a customer and an agent. In example, in chat 1, a customer may interact with a customer every 30 seconds. Accordingly, an agent handles a single interaction at a time leading to a concurrency value of 1.

FIG. 9B discloses a schematic illustration of interaction sequences for a case in which an agent handles three interactions (chats 1, 2 and 3) concurrently. Since the chats are handled concurrently, the response time of an agent in the individual chats may increase since an agent may interact with customer A of chat 1 at a time when they are provided with a question by customer B in chat 2. Accordingly, the latency in response time may increase in chats 1, 2 and 3 as indicated by sections 910.

An ACD, e.g. ACD 404, may assign an agent to interaction requests based on skills of an agent. Agents may be assigned agent skills, e.g. based on their experience in handling customer interactions. Based on their skills, a number of parallel interactions for each channel may be set, e.g. concurrent assignment of one voice call, ten emails, or ten chats. In another example, an agent may interact in ten interactions at the same time. A customer request for an interaction with an agent of a contact center, a request may specify or may indicate a required skill, e.g. return of purchase items, of an agent for the agent customer interaction request. In case that an agent with a skill is found that matches the skill of a customer request for an interaction, the customer may be assigned to the agent, e.g. an interaction between agent X and customer Y is initiated or customer Y may be assigned to a waiting loop until agent X can handle the interaction request. Customer requests can differ significantly in the required time an agent needs to solve a particular customer query. Thus, the estimation of a required handling time for an interaction may allow equally distributing customer requests to one or more agents of a contact center based on predicted handling times which can be derived from a customer interaction request. The estimation of handling times of interactions may be based on machine learning models, e.g. a long short-term memory (LSTM) network.

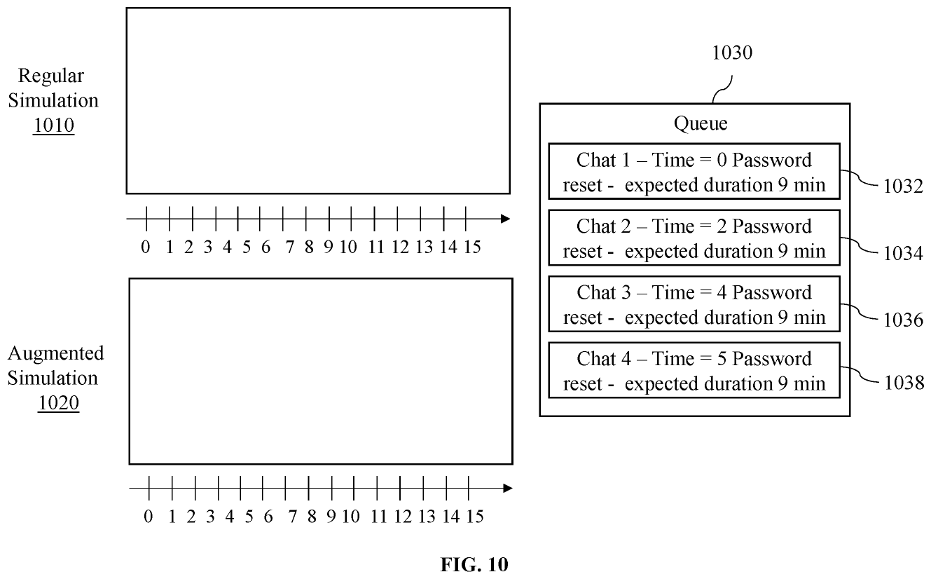

FIG. 10 illustrates a distribution of interaction data to agents, e.g. in the assignment of a first interaction, e.g. chat 1, to an agent, e.g. agent 1, in a regular simulation (1010) as known in the art and in an augmented simulation (1020). For example, agent 1 has the skill to handle three interactions concurrently. A queue (1030) may include a number of interaction requests for agent 1, e.g. four interactions 1032, 1034, 1036 and 1038, a required agent skill for each interaction and a predicted duration for each interaction, e.g. 9 minutes.

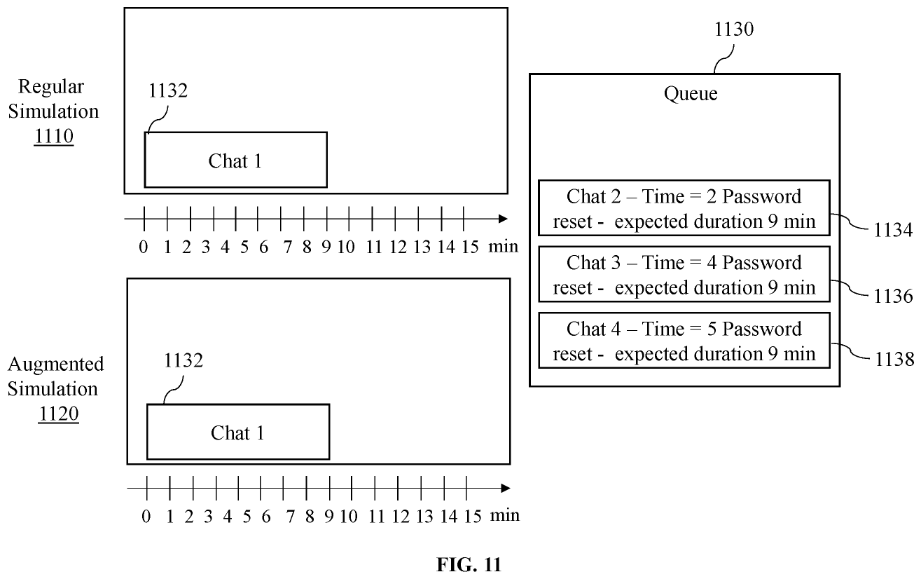

FIG. 11 illustrates an assignment of a first interaction, e.g. chat 1, to agent 1 in a regular simulation (1110) and in an augmented simulation (1120). After the assignment of a first interaction (1132) of queue 1130, e.g. when agent 1 is interacting with customer 1 in chat 1, a maximal latency time may be assigned to an interaction, e.g. between 30 sec. to 120 sec. For example, agents of a contact center may be instructed to reply to a customer within an interaction within a time of 30 seconds. When an interaction is assigned to an agent, a concurrency counter may be set to a value that reflects the number of ongoing interactions for an agent. For example, in case that an agent handles a single interaction, a concurrency counter may have a value of 1.

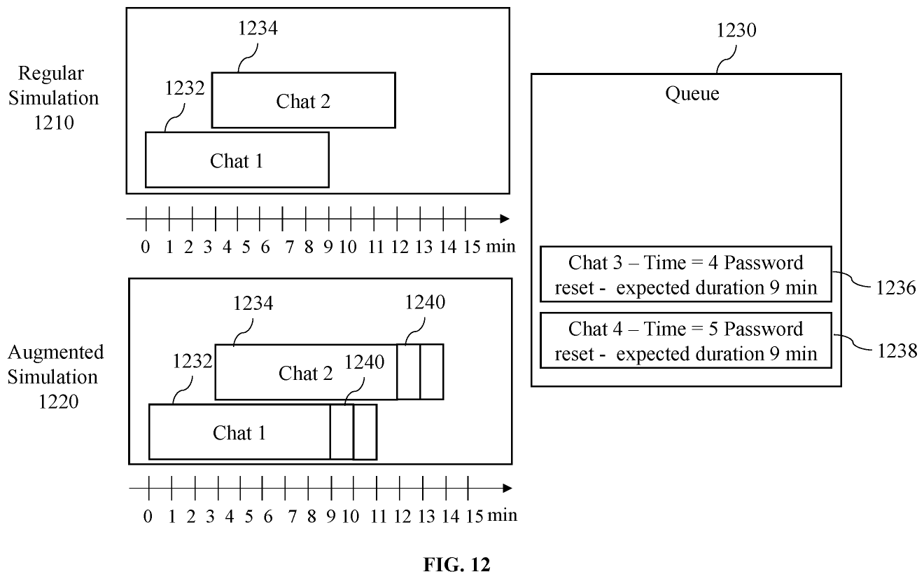

FIG. 12 illustrates an assignment of a second interaction, e.g. chat 2, to agent 1 in a regular simulation (1210) and in an augmented simulation (1220). During an interaction, e.g. when agent 1 interacts with customer 1 in chat 1 (1232), a second chat 1234 may be assigned to agent 1. A queue (1230) may include a number of interaction requests for agent 1, e.g. two interactions 1236 and 1238. An assignment of a second chat to an agent may increase a concurrency counter to a value of 2. A ML model, e.g. model 408, may predict interaction events for chat 1 taking into account that the concurrency value has increased from 1 to 2. For example, a ML model may predict a new termination event for chat 1. When an agent handles two interaction concurrently, a machine learning model may increase predicted response times of an agent responding to a customer message from 30 s to 60 s. A duration of an interaction may increase by a time slots 1240, e.g. a timeslot of 60 seconds. For example, chat 1 had an expected duration of 9 minutes at a concurrency level of 1, but may have an expected duration of 10 minutes at a concurrency level of 2. A matching engine, e.g. matching engine 406, may receive output, e.g. predicted interaction events from a ML model, e.g. ML model 408, and may update agent's availability based on predicted interaction events. For example, when a termination event for chat X is updated to an expected termination time, a matching engine 406 may update availabilities of agents to interaction requests from customers (operation 432) to an earlier or later point in time. As a result, matching engine 406 may amend suggestions for matches between agents and customers (operation 434) which are sent to ACD 404. A matching engine 406 may distribute interaction data, e.g. in form of interactions or interaction requests, to agents based on updated interaction events of agents.

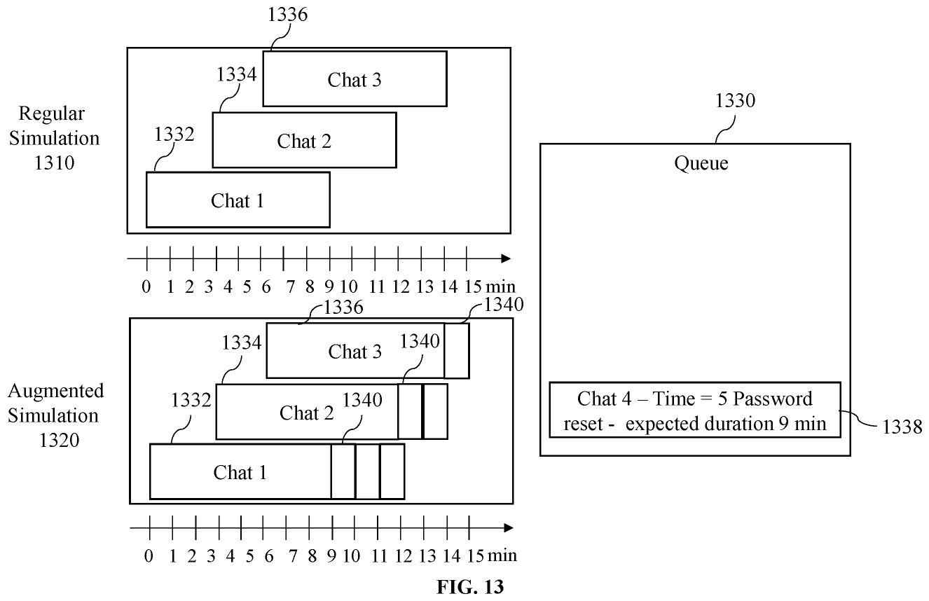

FIG. 13 illustrates an assignment of a third interaction, e.g. chat 3 (1336), to agent 1 in a regular simulation (1310) and an augmented simulation (1320). During an interaction, e.g. when agent interacts with customer 1 in chat 1 (1332) and customer 2 via chat 2 (1334), a third chat (1336) of queue (1330) may be assigned to agent 1, e.g. concurrently, when interactions between agent 1 and customer 1, and interactions between agent 1 and customer 2 are still ongoing. In this case, an agent may handle three interactions at the same time and a concurrency counter may have a value of 3.

A predicted response time, e.g. latency for subsequent chats, may affected by the number of concurrently executed chats. For example, the higher the number of pending chats, e.g. interactions between customers and agents, the longer it may take to complete the remaining chats. Accordingly latency may be increased, e.g. latency may be 60 seconds or higher for a concurrency level of 2 and 90 seconds or higher for a concurrency level of 3.

In case of an assignment of a fourth chat (1338) to an agent, latency may be 120 seconds including a 60 seconds duration increase.

Latency for chats may be predicted for different concurrency levels as shown in FIG. 13. For example, at a concurrency level of 1 a latency may be 30 seconds, at a concurrency level of 2 a latency may be 60 seconds and at a concurrency level of 3 a latency may be 90 seconds. The estimation of latency times for different concurrency levels may allow predicting of completion times for an interaction based on expected concurrency levels.

Agents handling interactions in contact centers may interact with one or more customers in one or more interactions. For example, an agent may interact with customers in three chats 0, 1 and 2. Interaction metadata for each chat, e.g. interaction metadata for a sequence of events within a chat may be extracted and provided to an ML model. Events may include an initiation event of an interaction by a customer, e.g. by sending a customer interaction request, assigning of an agent, start of an interaction and termination of an interaction. Metadata, e.g. in form of time periods or points in time for the events, may be used in the training of the ML model.

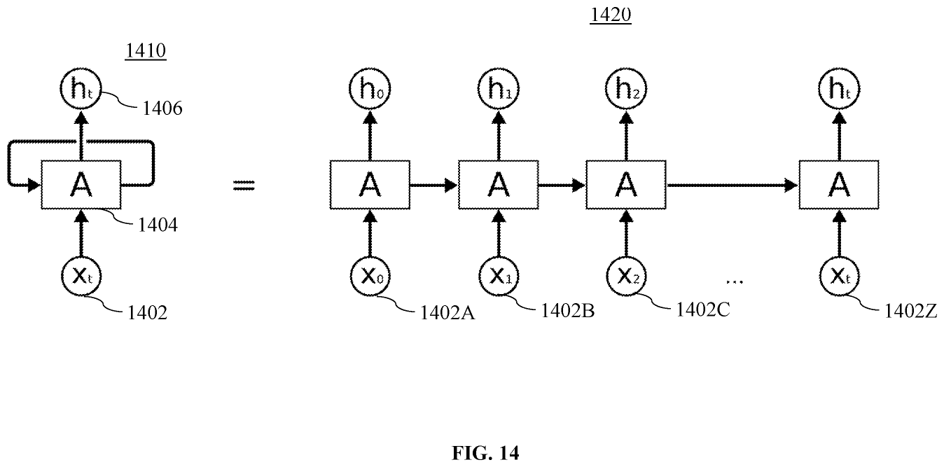

Retrieved metadata from an interaction, e.g. a time for start and end of an interaction, may be used by an ML model, e.g. ML model 408, in the generation of a sequence of events for an interaction as illustrated in FIG. 14. For example, start times and termination times may be sent to a ML model for each interaction of an agent, e.g. chat numbers 0, 1 and 2:

embedding_seq = \
[Embedding_event(time_since_start=0, start_or_end=‘start’, skill=‘Chat CS’,
index_in_group=0, ),
Embedding_event(time_since_start=18, start_or_end=‘start’, skill=‘Chat CS’,
index_in_group=1, ),
Embedding_event(time_since_start=34, start_or_end=‘start’, skill=‘Chat CS’,
index_in_group=2, ),
Embedding_event(time_since_start=293, start_or_end=‘end’, skill=‘Chat CS’,
index_in_group=0, ),
Embedding_event(time_since_start=1145, start_or_end=‘end’, skill=‘Chat CS’,
index_in_group=1, ),
Embedding_event(time_since_start=1208, start_or_end=‘end’, skill=‘Chat CS’,
index_in_group=2, )]

Interaction metadata for a plurality of previously recorded interactions may be used as training examples of a machine learning model, e.g. model 408, 630 or a model as shown in FIG. 14.

A sample sequence of interaction metadata such as interaction events for three interactions Chat 0, Chat 1 and Chat 2 is shown below and may include events such as an embedding event in relation to a start of an interaction in seconds. For example, metadata may include an item “time since start”. Each of the samples of interaction metadata may be submitted to a ML model, e.g. model 408. Model 408 may generate predicted times for interaction events, e.g. the termination of chats 0, 1 and 2. For example, 293 seconds may be a predicted end time for chat 0, 1145 seconds may be a predicted end time for chat 1 and 1208 seconds may be a predicted end time for chat 2:

[[Embedding_event(time_since_start=0, start_or_end=‘start’, skill=‘Chat CS’,
index_in_group=0),
Embedding_event(time_since_start=18, start_or_end=‘start’, skill=‘Chat CS’,
index_in_group=1),
Embedding_event(time_since_start=34, start_or_end=‘start’, skill=‘Chat CS’,
index_in_group=2)]]
0
293
[[Embedding_event(time_since_start=0, start_or_end=‘start’, skill=‘Chat CS’,
index_in_group=0),
Embedding_event(time_since_start=18, start_or_end=‘start’, skill=‘Chat CS’,
index_in_group=1),
Embedding_event(time_since_start=34, start_or_end=‘start’, skill=‘Chat CS’,
index_in_group=2)
Embedding_event(time_since_start=34, start_or_end=‘end’, skill=‘Chat CS’,
index_in_group=0)]]
1
1145
[[Embedding_event(time_since_start=0, start_or_end=‘start’, skill=‘Chat CS’,
index_in_group=0),
Embedding_event(time_since_start=18, start_or_end=‘start’, skill=‘Chat CS’,
index_in_group=1),
Embedding_event(time_since_start=34, start_or_end=‘start’, skill=‘Chat CS’,
index_in_group=2)
Embedding_event(time_since_start=293, start_or_end=‘end’, skill=‘Chat CS’,
index_in_group=0)
Embedding_event(time_since_start=1145, start_or_end=‘end’, skill=‘Chat CS’,
index_in_group=1]]
2
1208

A recurrent neural network model (RNN) as shown in FIG. 14 (in a compressed form 1410 and in an unfolded form 1420) may be used to estimate future events based on processed events using a generated memory. Input (1402) in the generation of a memory A (1404) for estimation of future events may be an event, e.g. interaction metadata (1402A, 1402B, 1402C, 1402Z) associated with an event of an interaction, e.g. interaction start time or a previous state within the model. Output for a received event or previous state may be a cell state for the next time step (1404) or a cell state for prediction (1406). Events are processed one by one and stored in form of memory.

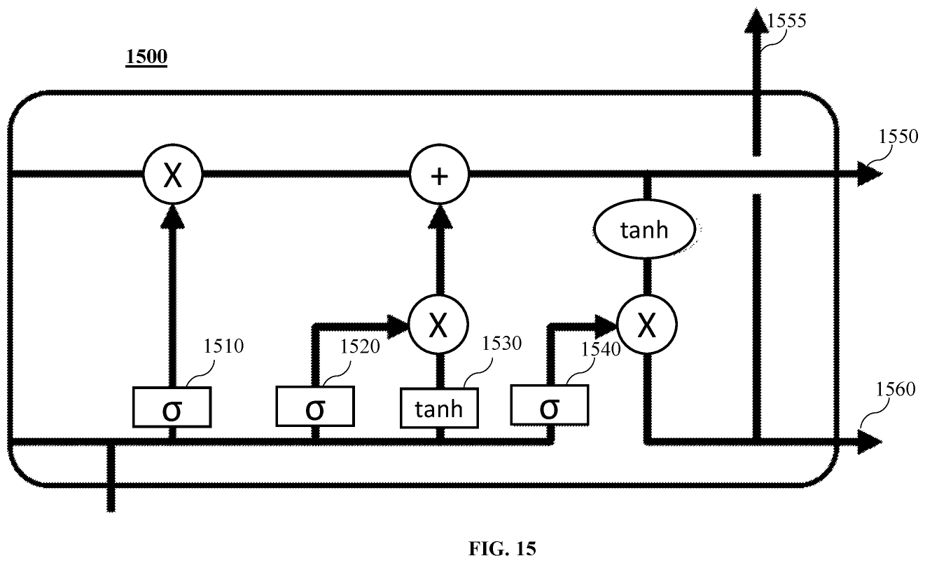

A sequence model utilizing LSTM model may include the following structural components: FIG. 15 shows an example LSTM network structure. The difference between the architectures of RNNs and LSTMs may lie in a hidden layer of LSTM which may be a gated unit or gated cell 1500. It may include four layers (1510, 1520, 1530 and 1540) that interact with each other to generate an output of the cell 1555 along with a cell state 1550 and a hidden state 1560. Cell state 1550 and hidden state 1560 may be passed onto the next hidden layer. Unlike RNNs which have only a single neural net layer of tanh, LSTMs may include three logistic sigmoid gates 1510, 1520 and 1540 and one tanh layer 1530. Gates may be introduced to limit the information that is passed through a cell. They may determine which part of the information will be needed by a next cell and which part can be discarded. Output may be in the range of 0-1 where ‘0’ means ‘reject all’ and ‘1’ means ‘include all’.

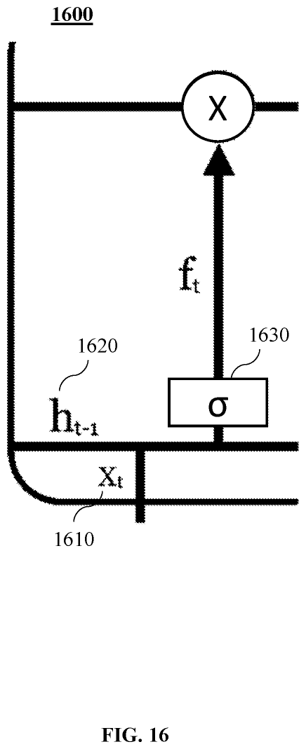

FIG. 16 illustrates an example of a forget gate 1600 of an LSTM model. Data items which are no longer required in the estimation of interaction events in a cell state may be removed, e.g. deleted. Two inputs xₜ (1610, input at the particular time) and hₜ₋₁ (1620, previous cell output) may be received by a forget gate 1600 and may be multiplied with weight matrices followed by the addition of bias. The result may be passed through an activation function, e.g. in form of a sigmoid function 1630. If for a particular cell state an output value has a value of 0, the piece of data may be deleted, e.g. classed as forgotten, and for an output value of 1, a piece of data may be retained for future use by the LSTM model.

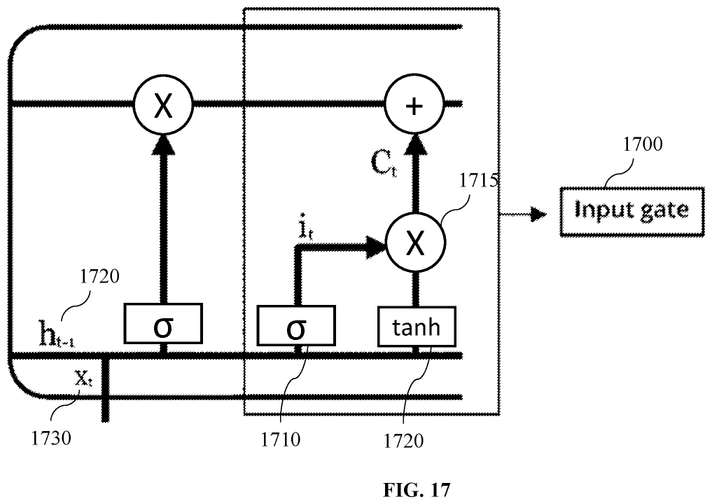

FIG. 17 illustrates an example of an input gate 1700 of an LSTM model. An LSTM model may retrieve input for cell states within a model, e.g. for the estimation of events, via an input gate 1700. First, data items may be regulated using sigmoid function 1710 and filter values it to be remembered similar to the forget gate using inputs hₜ₋₁ (1720) and xₜ (1730). Then, a vector 1715 may be created using a tanh function that may generate an output value between −1 to +1, which may include all possible values for hₜ₋₁ and xₜ. Values of vector 1715 and regulated values may be multiplied to predict interaction events, e.g. response time experienced by a customer, contact duration, customer satisfaction, etc.

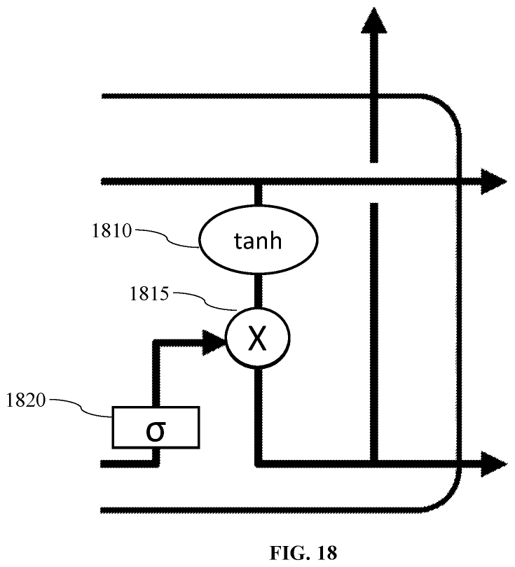

FIG. 18 illustrates an example of an output gate 1800 of an LSTM model. An output gate may extract a representation of the previous context for future predictions from a current cell state to be presented as output. A vector 1815 may be generated by applying tanh function 1810 on a cell. Information may be regulated using a sigmoid function 1820 and filtered by values to be remembered using inputs hₜ₋₁ and xₜ. At last, the values of the vector and the regulated values are multiplied to be sent as an output and input to a next cell of an LSTM model.

An LSTM neural network may be built and trained to predict the response time of chat in following manner: Datasets may be split into training and testing sets, for example in a 80:20 ratio training data to testing data. Data may be reshaped for an LSTM input. An LSTM model may be created, e.g. using Keras Sequential API. An LSTM model maybe compiled, e.g. by specifying the optimizer, loss function, and any metrics. An LSTM model may be trained, e.g. using training data. A trained LSTM model may be evaluated based on the used training data set. The trained neural network model may then be used to make estimations, e.g. to estimate response times for the assignment of new chats to agents of a contact center.

Example operations for the generation of an LSTM model:

### 1. Preparation of Interaction Data:

For example, an LSTM neural network may be trained to predict interaction events in following example manner:

As a part of data preparation stage, previously recorded interaction transcripts have been used. E.g. start times, end times and response times of previous interactions may be extracted from chat data csv which may include information on interactions such as start time, end time and the response time. A response time of a chat may be the time it takes for an agent to reply to a customer query. An example set of start time, end time and response time for interactions of an agent is shown below:

| start_time, | end_time, | response_time |
|---|---|---|
| 2022-01-01 10:00:00, | 2022-01-01 10:30:00, | 15 |
| 2022-01-01 12:45:00, | 2022-01-01 13:30:00, | 20 |
| 2022-01-02 08:15:00, | 2022-01-02 09:00:00, | 25 |
| 2022-01-02 4:30:00, | 2022-01-02 15:15:00, | 18 |
| 2022-01-03 1:45:00, | 2022-01-03 12:15:00, | 22 |

### 2. Data Collection Stage

Data sets of interaction metadata for an interaction may be extracted, e.g. from a CSV (comma-separated values) file and may be stored in a data library, e.g. Pandas library. Datasets may be imported into a database, e.g. via an example prompt excerpt shown below:

In [ ]: import pandas as pd
df = pd.read_csv(“chat_dataset.csv”)

Interaction durations may be calculated, e.g. using an imported start time and end time, e.g. via an example prompt excerpt shown below:

In [ ]: df[“chat_duration”] = pd.to_datetime(df[“end_time”]) -
pd.to_datetime(df[“start_time”])
df[“chat_duration”] = df[“chat_duration”].dt.total_seconds( )

Relevant calculated data, e.g. ‘chat_duration’ as the feature and ‘response_time’ as the target may be used in the training of the neural network, e.g. using prompt X:

In [ ]: x = df[[“chat_duration”]].values
y = df[“response_time”].values

Values of features, e.g. chat duration, and targets may be normalized, e.g. to be included in a range between 0 and 1 using an example prompt excerpt shown below:

In [ ]: from sklearn.preprocessing import MinMaxScaler
Scaler_X = MinMaxScaler( )
x = scaler_x.fit_transform(x.reshape( −1, 1))
Scaler_Y = MinMaxScaler( )
y = scaler_y.fit_transform(y.reshape( −1, 1))

### 3. Training Stage

Retrieved datasets may be split into training and testing datasets, e.g. in a 80:20 ratio using an example prompt excerpt shown below:

In [ ]: from sklearn.model_selection import train_test_split
X_train, x_test, y_train, y_test = train_test_split(X, y, test_size=0.2,
random_state=42)

Reshape the datasets to be compatible for use as LSTM input.

In [ ]: X_train = X_train.reshape((X_train.shape[0], 1,
X_train.shape[1]))
X_test = X_test.reshape((X_test.shape[0], 1, X_test.shape[1]))

An LSTM model may be generated, e.g. using a Keras Sequential application programming interface developed by google, using an example prompt excerpt shown below: In [ ]: from tensorflow.keras.models import Sequential

from tensorflow.kreas.layers import LSTM, Dense
model = Sequential( )
model.add(LSTM(50, activation=”relu”, inpt_shape=(1,
X_train.shape[2])))
model.add(Dense(1)) # Output layer with 1 neuron for reression task

A generated LSTM model may be compiled, e.g. by specifying the optimizer, loss function, and any metrics, e.g. using an example prompt excerpt shown below:

In [ ]: model.compile(optimizer=“adam”, loss=“mse”) #Mean Squared
Error loss for regression

During the training, a model may be provided with training data, e.g. using an example prompt excerpt shown below:

In [ ]: model.fit(X_train, y_train, epochs=50, batch_size=32,
validation_data=(X_test, y_test))

### 4. Evaluation of the Model

Evaluation of the performance of an LSTM model may proceed by calculating a mean squared error for the model, for example, according to an example prompt excerpt shown below:

In [ ]: mse = model.evaluate(X_test, y_test)
Print(f’Mean Squared Error on test set: {mse}’)

Estimations for chat interaction durations may be made using an example prompt excerpt shown below:

In [ ]: # Example: Predict response time for a new chat duration
new_chat_duration = np.array([[10, 15]]) # past chat durations
new_chat_duration = new_chat_duration.reshape((1, 1,
new_chat_duration.shape[1]))
predicted_response_time = model.predict(new_chat_duration)

Predictions of response times for a new interaction, e.g. a chat between an agent and a customer may be based on a trained neural network using LSTM.

The following simulation results may provide examples of features of the trained neural network:

Table 1 shows a simulation result for interactions 1 and 2. Actual duration in first row is 276 seconds and one made by an example algorithm is 274 seconds which shows a deviation of 2 seconds.

TABLE 1

| | Skill | | | Actual | | | Prediction |
|---|---|---|---|---|---|---|---|
| Chat ID | name | Date | Interval | duration | Prediction | AHT | error |
| 1 | Chat | 2021 Jun. 30 | 58 | 276 | 74 | 910 | 2 |
| | CS | | | seconds | | | |
| 2 | Chat | 2031 Jun. 30 | 65 | 955 | 1013 | 755 | −58 |
| | CS | | | seconds | | | |

Table 2 shows an example evaluation of Parameter NN Gain. Parameter NN Gain can be calculated as the difference between absolute AHT error and absolute prediction error and may indicate a degree of accuracy of the neural network. For example, a value close to 0 may indicate high accuracy of a predicted interaction event by a neural network and a high value of NN Gain, e.g. 2000, may indicate a low accuracy of a neural network.

TABLE 2

| | Support | Absolute | | |
|---|---|---|---|---|
| | [numerical | prediction | Absolute AHT | NN Gain |
| Skill name | samples] | error [sec] | error [sec] | [sec] |
| Chat CS | 10167 | 319 | 1340 | 1021 |
| Chat CS | 15 | 170 | 922 | 752 |
| cancelled | | | | |
| Chat CS Level 3 | 7 | 89 | 230 | 141 |
| Chat CS TFS | 7189 | 292 | 1304 | 1012 |
| Chat Fan Seller | 1845 | 179 | 302 | 123 |
| Chat OF | 226 | 356 | 274 | −82 |
| Chat Sales | 6 | 290 | 1190 | 900 |
| Chat Seller | 455 | 161 | 275 | 114 |

Table 3 includes a list of interaction metadata items which may be extracted from interaction metadata of an interaction.

TABLE 3
Interaction Metadata

tenantId: String
interactionId: String
interactionDuration: Number
interactionStartTime: Number
interactionEndTime: Number
interactionDate: Date
routingSkills: String
agentID: String
customerFeedback: Number

Table 4 includes interaction metadata items related to an agent taking part in an interaction, e.g. interaction specific data including maximum Concurrent Count during that interaction and minimum concurrency count to get more specifics of cognitive load during interaction

TABLE 4
AgentData

tenantId_interactionId: String
agentID: String
maxConcurrencyCount: Number
minConcurrencyCount: Number

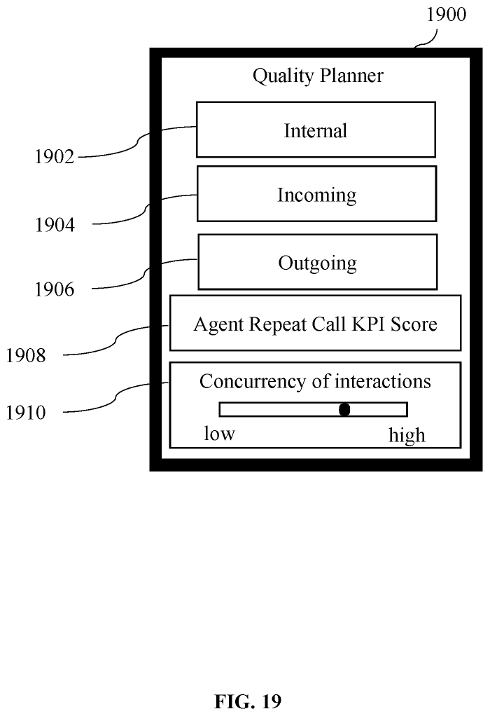

FIG. 19 shows an example user interface for distributing interaction data to agents. A quality manager or supervisor of agents of a contact center may review internal (1902), incoming (1904), outgoing (1906) interactions and key performance indicators (1908) for each individual agent and can use a quality planner application 1900, e.g. to select a specific range of concurrent interactions 1910 for an agent. This may be utilized as a filter for distributing interactions of an agent for evaluation activities.

Quality planner 1900 may distribute only recorded calls in which the number of concurrent interactions is between 2 and 4. Such interactions may be helpful since they can act as a data-point for an evaluator to perform evaluations for root cause into performance issues during concurrent interactions or may allow an assignment of coaching/training program to agents for skill improvement, e.g. in handling interaction requests. For example, a ML model, e.g. ML model 408, may be trained to predict customer satisfaction. Customer satisfaction may be optimized by selecting a concurrency value, e.g. to optimize response times for customers, and monitoring the impact of a selected concurrency value with respect to the customer satisfaction of a customer.

The aforementioned flowcharts and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

What is claimed is:

1. A method of distributing interaction data to agents, the method comprising:
identifying one or more interaction events from interaction metadata items located in one or more interactions assigned to an agent;
generating a prediction prompt for estimating one or more future interaction events for said one or more interactions based on said identified interaction events; and
applying said prediction prompt to a machine learning model to estimate said one or more future interaction events for said one or more interactions.

2. A method according to claim 1, wherein said one or more future interaction events comprise interaction termination.

3. A method according to claim 1, wherein said one or more future interaction events comprise initiating a new interaction.

4. A method according to claim 1, wherein estimating said one or more future interaction events comprises determining a latency in responses of said agent to one or more interactions.

5. A method according to claim 1, wherein estimating said one or more future interaction events comprises sequential initiation and termination of said one or more interactions, thereby maintaining a concurrent assignment of interaction requests to said agent.

6. A method according to claim 1, comprising identifying an interaction capacity of said agent from said interaction metadata items; and
evaluating, using machine learning, whether said agent has capacity to receive a new interaction request.

7. A method according to claim 6, wherein said interaction capacity is identified based on the evaluation of agent data items.

8. A method according to claim 6, wherein evaluating said interaction capacity of said agent comprises comparing an interaction latency of an agent to a threshold value.

9. A method according to claim 8, wherein said agent is available for receiving said new interaction request when said interaction latency is below said threshold value and wherein said agent is unavailable for receiving said new interaction request when said latency is above said threshold value.

10. A method according to claim 9, wherein when said agent is unavailable for receiving an interaction request, identifying another agent for receiving said interaction request.

11. A system for distributing interaction data to agents, the system comprising:
a computing device;
a memory; and
a processor, the processor configured to:
identify one or more interaction events from interaction metadata items located in one or more interactions assigned to an agent;
generate a prediction prompt for estimating one or more future interaction events for said one or more interactions based on said identified interaction events; and
apply said prediction prompt to a machine learning model to estimate said one or more future interaction events for said one or more interactions.

12. A system according to claim 11, wherein said one or more future interaction events comprise interaction termination.

13. A system according to claim 11, wherein said one or more future interaction events comprise initiating a new interaction.

14. A system according to claim 11, wherein said estimation of said one or more future interaction events comprises the determination of a latency in responses of said agent to one or more interactions.

15. A system according to claim 11, wherein said estimation of said one or more future interaction events comprises sequential initiation and termination of said one or more interactions, and maintenance of a concurrent assignment of interaction requests to said agent.

16. A system according to claim 11, comprising identification of an interaction capacity of said agent from said interaction metadata items; and
evaluation, using machine learning, whether said agent has capacity to receive a new interaction request.

17. A system according to claim 16, wherein said interaction capacity is identified based on the evaluation of agent data items.

18. A system according to claim 16, wherein said evaluation of said interaction capacity of said agent comprises comparing an interaction latency of an agent to a threshold value.

19. A system according to claim 18, wherein said agent is available for receiving said new interaction request when said interaction latency is below said threshold value and wherein said agent is unavailable for receiving said new interaction request when said latency is above said threshold value.

20. A method of predicting interaction events, the method comprising:
identifying a plurality of interaction events related to one or more interactions;
generating a prediction prompt for determining at least one future interaction event for said one or more interactions based on said interaction events; and
subjecting said prediction prompt to a machine learning model to determine at least one future interaction event.
